(19) United States
(12) Patent Application Publication
(10) Pub. No.: US 2018/0245392 A1
(43) Pub. Date: Aug. 30, 2018

(54) CABLE GUIDE ARRANGEMENT FOR A POWER-OPERATED VEHICLE SLIDING DOOR

(71) Applicant: FORD GLOBAL TECHNOLOGIES, LLC, Dearborn, MI (US)

(72) Inventors: Andreas Cousin, Koln (DE); Jochen Klingbeil, Dusseldorf (DE)

(21) Appl. No.: 15/856,955

(22) Filed: Dec. 28, 2017

(30) Foreign Application Priority Data
Feb. 24, 2017 (DE) 102017203008.9

(51) Int. Cl. E05F 15/643; B60J 5/06; E05D 15/16

(52) U.S. Cl. CPC E05F 15/643; E05Y 2900/531; E05D 15/165; B60J 5/06

(57) ABSTRACT

A cable guide arrangement is provided for a power-operated vehicle sliding door, having a driven traction cable which is diverted by means of a roller system. The roller system has a holder in which there is mounted a diverting roller by means of which the traction cable, guided through the holder, is diverted. A guide channel is formed on the holder. The traction cable is guided through the guide channel to the diverting roller. The guide channel has at least one guide surface by means of which the traction cable, when it bears against said guide surface, is diverted in the direction of a tangential profile in relation to the diverting roller.

### TECHNICAL FIELD

This document relates to a cable guide arrangement for a power-operated vehicle sliding door, having a driven traction cable which is diverted by means of a roller system. The roller system has a holder in which there is mounted a diverting roller by means of which the traction cable guided through the holder is diverted.

### BACKGROUND

Motor vehicles such as minibuses and delivery vehicles for passengers and cargo are often equipped with lateral sliding doors. In recent times, sliding doors have however also been used in relatively large passenger motor vehicles in order, in particular, to facilitate the embarking and disembarking and the loading and unloading of a vehicle. Such sliding doors may be actuated by hand, though use may also be made of driven or power-operated sliding doors. This facilitates the opening and closing of the doors.

Various drive devices are already known for moving a vehicle sliding door of said type. Typical types of drive devices comprise a traction cable system, in which the door is connected to at least one traction cable, which in turn is movable back and forth by a drive. To guide and/or divert a cable that is used here, use is often made of roller systems. Such cable and roller systems may be of varied design.

U.S. Pat. No. 5,316,365 A has disclosed, for example, a door opening and closing system for vehicle sliding doors, in the case of which a continuous cable loop is used. The cable loop can be driven in two directions in order to open and close the sliding door. Here, use is made of cable drive wheels with cable grooves of different size, which can be used in each case for low- and high-speed sliding door movements. Low speeds prevail in particular during the latching of the door.

JP 3907249 B2 discloses a guide system for a cable of a vehicle sliding door, which guide system likewise has a roller over which the cable runs. Said roller is spring-mounted in order to ensure a uniform movement of the door.

Guides for wires, cables or belts are also known from other sectors. For example, DE 20 2015 003 451 U1 discloses a suspension means for an electrical wire, in the case of which a cable roller is used over which the wire is guided in order to always provide a gentle bend radius. It is sought in this way to prevent damage to the wire. JP 2005207555 A describes a mechanism for compensating incorrect positioning of rollers within a belt drive. By contrast, DE 197 28 708 C2 describes an arrangement for installation of a wiring loom into an automobile door. Here, the wiring loom runs through a protective device which is mounted in slidable fashion on a door panel.

DE 10 2007 016 815 A1 relates to a driven sliding door system for a building. Here, use is made of linear guides with guide profiles, wherein a limb of a guide profile bears the weight of a sliding door leaf. A limb of a second guide profile jointly bears this weight.

Roller systems for power-operated vehicle sliding doors often use multiple rollers for suitably guiding a driven traction cable in the different movement states of the cable. Here, allowance must be made in particular for the fact that a sliding door, as it is moved in and out, is often guided in an angled or curved rail in order to firstly move the sliding door out of the vehicle shell and then move said sliding door along the outside of the vehicle shell. Use is typically made of an upper, a lower and a middle rail, wherein a traction cable runs in the middle rail. A roller system is often mounted at the curved end of a middle rail of said type. Said roller system diverts the traction cable, at the end of the rail, through the side wall of the vehicle around an edge.

When the door is in a closed state, it is typically the case, owing to the structural conditions, that the traction cable lies slightly adjacent to the inner flank of the rail. When the door is opened, the traction cable loops around the angled region of the rail. In this way, during the opening and closing of the door, an angular offset arises in the profile of the traction cable, which angular offset must be allowed for by the roller system at the end of the rail. Often, for this purpose, use is made of highly complex roller systems with more than one roller, which are intended to reduce the friction and change the profile of the cable. These are thus vehicle components which are relatively complex to produce, such that there is a demand for simplification.

In view of the prior art described, the field of roller systems for cable drives of power-operated vehicle sliding doors therefore still leaves room for improvement.

### SUMMARY

In accordance with the purposes and benefits described herein, a power-operated vehicle sliding door is provided with a cable guide arrangement that uses a roller system which is easy to produce and by means of which a traction cable can be diverted. In particular, it is the intention here to use a roller system which allows for an angular offset in the profile of the traction cable during the opening and closing of the vehicle sliding door.

It is pointed out that the features and measures specified individually in the following description may be combined with one another in any desired technically meaningful way and disclose further refinements of the cable guide arrangement. The description, in particular in conjunction with the figures, characterizes and specifies the cable guide arrangement further.

The cable guide arrangement for a power-operated vehicle sliding door has a driven traction cable which is diverted at at least one point by means of a roller system. Said roller system has a holder in which there is mounted a diverting roller by means of which the traction cable guided through the holder is diverted. According to the invention, on said holder, there is formed a guide channel through which the traction cable is guided to the diverting roller. The guide channel has at least one guide surface by means of which the traction cable, when it bears against said guide surface, is diverted in the direction of a tangential profile in relation to the diverting roller. Thus, if a traction cable runs at an angle relative to the diverting roller which, without diversion, would lead to an excessively oblique introduction of the traction cable into the diverting roller, at least one guide surface has the effect that the traction cable, when it bears against said guide surface, is diverted in the direction of a tangential profile relative to the diverting roller. This is achieved by means of a corresponding arrangement and form of the at least one guide surface.

In this way, axial forces on the diverting roller can be reduced. Here, a tangential profile into the diverting roller can be achieved, though even simply an approximation to a tangential profile can constitute an improved profile of the traction cable. Therefore, the traction cable is diverted in the direction of such a tangential profile, wherein the tangential profile does not have to be fully achieved.

A guide surface may be formed in a variety of suitable ways. For example, the guide channel may have at least one curved or domed guide surface, the convex side of which points toward the diverting roller. The guide surface is arranged such that a traction cable, when it bears against the convex side, is diverted in the direction of a tangential profile into the diverting roller. Here, the curved surface permits a uniform diversion of the traction cable without stress peaks.

In another embodiment of the cable guide arrangement, the guide channel has at least one angled guide surface, the angular deflection of which on the side of the diverting roller has a reflex angle β. The angle β lies for example in the range from 185 to 225°, and is in particular approximately 200°. Here, such a guide surface may be formed by two surface sections which, as viewed from the traction cable, run at the stated reflex angle β relative to one another. An edge is thus formed at the transition between the two sections. Said edge is however preferably of rounded form on the side of the diverting roller. Furthermore, not all regions of a guide surface must be in contact with the traction cable. Rather, the possible contact may also be restricted to the (rounded) edge in the region of the angular deflection and a partial section of one guide surface.

The guide channel may be delimited by at least two guide surfaces. Owing to the angular deflection or curvature of the at least one guide surface, a diverting region is formed on the respective guide surface, by means of which diverting region a traction cable can, regardless of its entry into the roller system, be led into a predefined profile relative to the diverting roller, if this is necessary. If, in a particular position of the sliding door, a traction cable enters centrally into a guide channel of the holder, it is for example the case that no contact occurs with said diverting region, and the traction cable can move freely in a particular angle range around said central passage. Said free angle range is for example selected such that, within said angle range, the traction cable is fed to the diverting roller still in a manner adequately close to a tangential feed configuration.

By contrast, if the traction cable enters the holder of the roller system at a different angle, this is possible only within an angle range permitted by the profile of the guide surface(s). If a particular angle is overshot, the traction cable is diverted into a direction which lies closer to a tangential feed configuration.

By means of the guide channel thus formed with at least one angled guide surface, a possible angular offset in the profile of a traction cable can be allowed for. For this purpose, no further rollers aside from a diverting roller are used, it rather being the case that the guidance can be performed exclusively by means of one or more guide surfaces. The guide surfaces used are thus not rotating surfaces of diverting rollers but fixed surfaces. The roller system is thereby considerably simplified. It can be produced more easily, and is also more robust as regards possible wear and damage.

Different positions can be selected for the position of the diverting region of the at least one guide surface. The angle of an angular deflection or the degree of the curvature of a guide surface may also be selected differently as long as they ensure tangential or approximately tangential run-in of the traction cable into the guide roller in the event of an angular offset. The position and magnitude of the angular deflection or of a curved diverting region are also dependent in particular on the arrangement of the guide surface relative to the diverting roller. In one embodiment of the cable guide arrangement, at least one guide surface runs, in the region of the diverting roller, substantially parallel to the plane of the diverting roller. Thus, at least one guide surface is situated adjacent to the plane of the diverting roller and diverts traction cable profiles out of said region into a direction of a tangential profile relative to the diverting roller.

In the case of a guide surface with a surface normal orthogonal to the axis of rotation of the diverting roller, it has for example proven to be advantageous for the angular deflection or curvature to be situated in a region which lies outside a wrap sector in which the traction cable makes contact with the diverting roller in the event of central passage through the guide channel. In this way, an adequately large spacing of the edge of the angular deflection or of the curvature to said wrap sector always permits a reliable feed of the traction cable to the diverting roller without jerking movements of the cable occurring.

By contrast, in the case of a guide surface which runs substantially orthogonally with respect to the axis of rotation of the diverting roller, it is advantageous if the position of the angular deflection or curvature is selected such that the traction cable, as it slides along the guide surface, imparts as far as possible only low axial forces to the diverting roller. The diverting roller has for example an encircling groove in which the traction cable runs during the diversion. The traction cable should be fed to the groove at as small an angle as possible relative to the plane of the diverting roller, preferably tangentially relative to the diverting roller. The diverting region of a guide surface is thus preferably arranged correspondingly close to the diverting roller but also correspondingly remote from the axis of rotation of the diverting roller.

The guide channel may thus be delimited by multiple guide surfaces which are each arranged differently relative to the diverting roller. It is thus possible for the profile of a traction cable to be advantageously guided to the diverting roller from different directions. It is furthermore also possible for multiple coherent guide surfaces to form a guide channel. For example, in one embodiment of the cable guide arrangement, it is provided that multiple guide surfaces form a funnel, by means of which a conically tapering guide channel with an opening angle α is formed.

In a further embodiment of the cable guide arrangement, multiple guide surfaces form a partial funnel which points with an open longitudinal side toward the diverting roller. The guide surfaces thus form a type of curved shield, the concave side of which points toward the diverting roller. In the region of said guide surfaces, a traction cable would therefore be guided in the direction of the diverting roller.

In the various embodiments of the guide channel, the resulting opening angle α of the guide channel lies for example between 15° and 45°, and is in particular approximately 30°. It is however also possible for other, and in particular smaller, opening angles α to be selected. An opening angle α of 0° may also be used, wherein multiple guide surfaces then form not a conically tapering funnel but a merely tubular guide channel with parallel walls. Even with such a guide channel, it is possible for a traction cable, when it bears against a guide surface, to be diverted in the direction of a tangential profile relative to the diverting roller.

Furthermore, the at least one guide surface preferably has a surface with low friction coefficient, in particular a surface composed of polytetrafluoroethylene (PTFE/Teflon). This improves the sliding of the traction cable along the respective guide surface. As materials for the surface of a guide surface, use may also be made here of polyoxymethylene (POM), brass, etc.

The cable guide arrangement according to the invention may be used particularly advantageously if the roller system is mounted at the end of a rail through which the traction cable runs. Said rail may be one of several rails that are provided on the side wall of a motor vehicle. If use is made, for example, of two or three rails situated one above the other, said rail may be the lower, upper or middle rail. Such a rail has for example a curved section with an inner flank, the traction cable sliding along said inner flank of the curved section during the opening and/or closing of the vehicle sliding door. In such an embodiment, during the opening and/or closing of the vehicle sliding door, an angular offset of the traction cable relative to the guide roller arises, which can be allowed for by the roller system used without the need for using a multiplicity of rollers. The roller system may however also be advantageously used in the case of straight rails without curvature.

Here, the roller system may be installed in various orientations in the vehicle. A form of installation has for example proven to be advantageous in which, in the installed state of the cable guide arrangement, the diverting roller lies vertically, and its axis of rotation runs horizontally. The system may be used in particular if the traction cable is fed into the roller system from below in a vertical direction.

### BRIEF DESCRIPTION OF THE DRAWINGS

Further advantageous embodiments of the cable guide arrangement are disclosed in the following description and the figures. In the figures:

FIG. 1 is a schematic illustration of the curved end of a rail of a vehicle sliding door with an adjoining roller system,

FIG. 2 shows a first side view of an embodiment of a cable guide arrangement,

FIG. 3 shows a longitudinal section through a cable guide arrangement as per FIG. 2,

FIG. 4 shows an enlarged illustration of the guide channel of a cable guide arrangement,

FIG. 5 shows a three-dimensional view of a cable guide arrangement,

FIG. 6 shows a second side view of a cable guide arrangement,

FIG. 7 shows a three-dimensional view of a holder for a cable guide arrangement; and

FIG. 8 shows a longitudinal section through a holder as per FIG. 7.

In the different figures, identical parts are always provided with the same reference signs, and so said parts are generally also described only once.

### DETAILED DESCRIPTION

The cable guide arrangement may be used in various embodiments of power-operated vehicle sliding doors which use driven traction cables for moving the sliding door. It is suitable in particular for the diversion of a driven traction cable at the end of a middle rail which is situated on the vehicle side wall. It may however also be used in the case of differently arranged rails. By means of the roller system used, the traction cable is, in said region, guided through the side wall of the vehicle around an edge. The invention will be described in more detail on the basis of such an embodiment using the figures, though the invention is not restricted to such a use at the end of a middle rail.

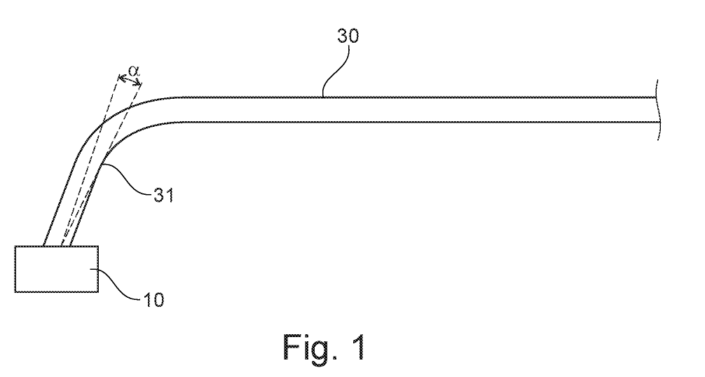

FIG. 1 shows a schematic illustration of the end of a rail 30 at which a roller system 10 is arranged. In the illustrated end region, the rail 30 is curved, such that a traction cable which is led from the roller system 10 through the rail 30 runs along said curvature. FIG. 1 schematically illustrates that the profile of the traction cable has a certain angular offset α relative to the guide roller during the opening and closing of the sliding door. When the door is in a closed state, the traction cable lies slightly adjacent to the inner flank 31 of the rail 30. When the door is opened, the traction cable loops around the inner flank 31 of the angled region of the rail 30.

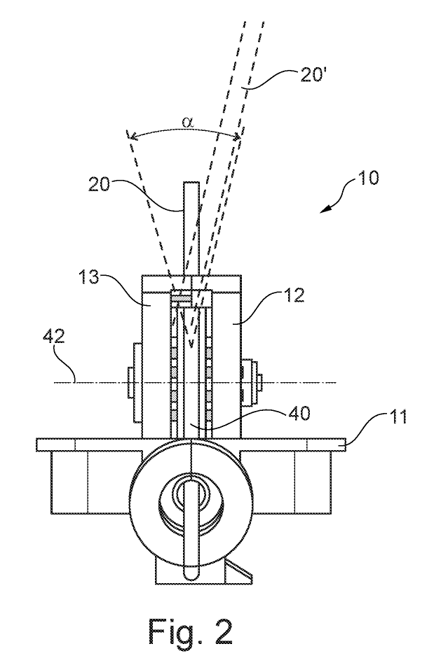

To allow for said angular offset α of the traction cable in the roller system 10, the roller system 10 has a guide channel through which the traction cable 20 is led. FIG. 2 shows a side view of a roller system 10, in which the guide channel has an opening angle α in this plane. Within this guide channel, the traction cable, when it bears against a guide surface of the guide channel, is diverted into a direction tangential with respect to the diverting roller 40. Even if the traction cable 20 emerges from the rail 30 non-tangentially with respect to the diverting roller 40, it is, in the region of the diverting roller 40, diverted into a tangential or approximately tangential profile with respect to the diverting roller. FIG. 2 shows, by way of example, and by dashed lines, a traction cable 20′ which emerges from the rail non-tangentially with respect to the diverting roller but which, by means of a guide surface arranged on the right in FIG. 2, is diverted toward the diverting roller 40 so as to run into the diverting roller 40 tangentially or approximately tangentially. In this way, axial forces on the diverting roller 40 can be reduced.

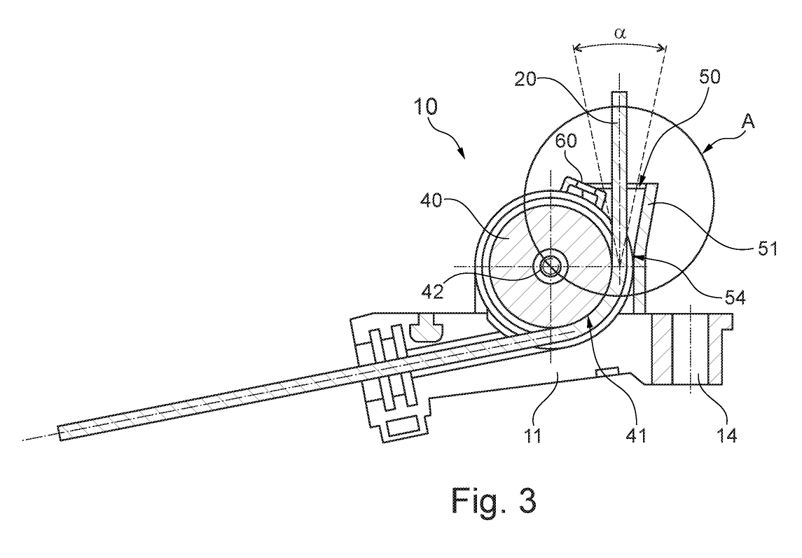

The guide channel 50 may also have an opening angle α in another plane. This can be seen in the side view of FIG. 3.

Here, the roller system 10 has a holder 11 on which a diverting roller 40 is mounted. The holder 11 may be designed to be suitable for being able to be mounted on and fixed to the side wall of a vehicle. In particular, it is for example possible for passage bores 14 or other fastening means to be provided for this purpose. The holder 11 may have a plate-like main body on which there are mounted two mutually spaced-apart bearing halves 12 and 13, between which the diverting roller 40 is rotatably mounted (FIG. 2). The holder 11 may however take on other forms and designs which make it possible for the diverting roller 40 to be rotatably mounted and which permit the feed and leading-away of a traction cable 20. In the exemplary embodiment of the figures, a traction cable 20 is guided through a guide channel 50 to the diverting roller 40 and wraps around the latter in the region of a wrap sector 41. Said wrap sector 41 encompasses a region of approximately 90° of the circumference of the diverting roller 40, and the traction cable 20 is diverted through approximately 90° in said sector. It is however also possible for other wrap angles, for example between 70° and 80°, to be selected. Here, the diverting roller 40 has, on its outer side, an encircling groove in which the traction cable 20 runs as it wraps around the diverting roller 40.

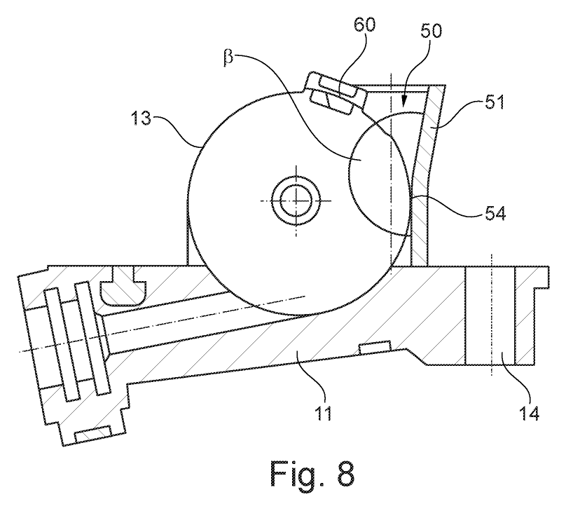

The guide channel 50 is delimited by at least one angled guide surface. The longitudinal section of FIG. 2 shows a section through a first guide surface 51 shown in FIG. 3. Said guide surface 51 has an angular deflection with a preferably rounded edge 54, which is situated outside the wrap sector 41. As a result of the angular deflection, the two sections of the guide surface 51 span, on the side of the diverting roller 40, a reflex angle β (see also FIG. 8). Furthermore, a connecting clip 60 is provided by means of which the two halves of the holder are connected to one another. The traction cable 20 runs between said connecting clip 60 and the first guide surface 51. If no large angular deviations are expected, and no axial forces are generated, in the direction of the connecting clip 60, no guide surface is required in said region. Therefore, the structural space can be used for the connecting clip.

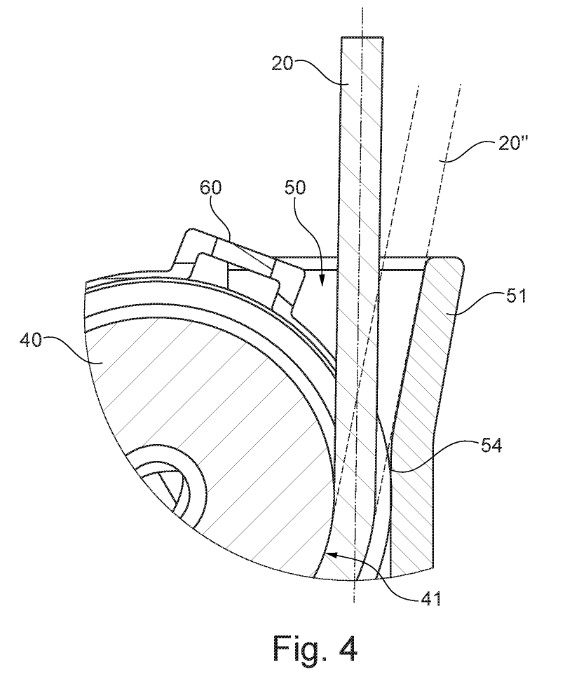

The region A of the roller system 10 (see FIG. 3) is shown in an enlarged detail in FIG. 4. From said enlargement, it can be seen in particular that the rounded edge 54 of the angled guide surface 51 is not situated in the region of the wrap sector 41 of the diverting roller 40. In this illustration, the traction cable 20 runs approximately centrally through the guide channel 50. In this profile, the traction cable 20 does not make contact with the guide surface 51, but rather runs directly into the groove of the diverting roller 40. However, if the traction cable 20 were to run into the roller system at a different angle, as shown by the possible angle range α of FIG. 3, this would be delimited on one side by the guide surface 51. FIG. 4 shows such an alternative profile of the traction cable by means of dashed lines, wherein here, the traction cable 20″ bears against the guide surface 51. The position of the rounded edge 54 of the guide surface 51 and the profile of the guide surface 51 are preferably selected such that, in this alternative profile, the traction cable is not kinked at the edge 54.

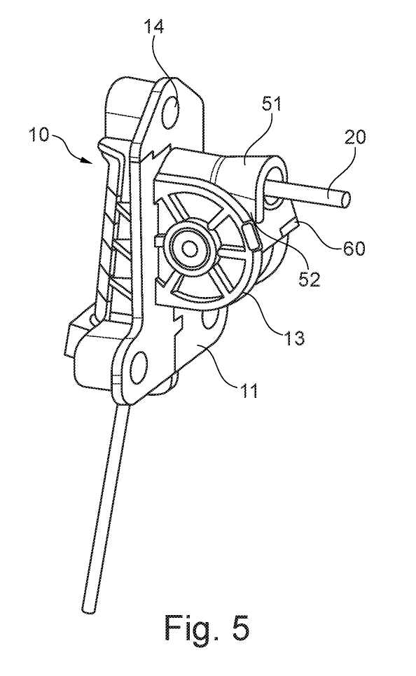

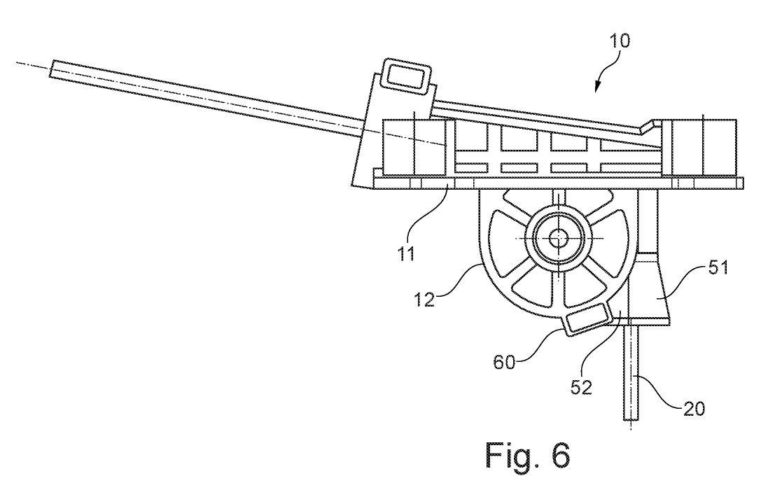

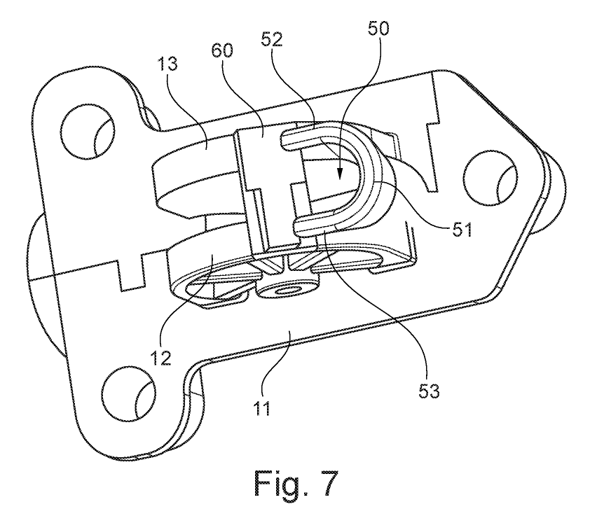

The guide channel 50 is however formed not only by the guide surface 51, with the guide channel 50 being delimited by further guide surfaces. By means of these, a funnel-shaped guide channel is formed, as can be seen from the three-dimensional view of FIG. 5 and the side view of FIGS. 6 and 7. Here, a guide surface 51 and two further guide surfaces 52 and 53 form a conically tapering half-funnel, with an open longitudinal side which points toward the diverting roller 40. The connecting clip 60 abuts against said open longitudinal side.

In FIG. 7, only the holder 11 is illustrated, without diverting roller and without traction cable. Here, the two guide surfaces 52 and 53 delimit an angular offset in the profile of a traction cable, which occurs in a plane parallel to the axis of rotation of the diverting roller. By means of the funnel shape of the guide channel, an angular offset may also occur in other planes. Traction cables 20 entering from a wide variety of directions can thus be guided to the groove of the diverting roller 40 in a targeted manner, in order that the traction cable runs into the diverting roller as tangentially as possible. Here, the angular deflections of the individual guide surfaces generate a preferably rounded edge which runs in an encircling manner on the inner side of the half-funnel.

To reduce axial forces on the diverting roller 40, it is therefore preferable for at least the two guide surfaces 52 and 53 which run parallel to the plane of the diverting roller to be provided. Without said guide surfaces 52, 53, a traction cable 20 would, in the case of an angular offset α, run excessively obliquely into the diverting roller 40. The guide surfaces 52 and 53 however run relative to the diverting roller 40 such that, in such a situation, they divert the profile of the traction cable into a direction tangential with respect to the diverting roller. The rounded edge 54 of the respective angled guide surfaces 52, 53 serves for this purpose, wherein said rounded edge 54 is preferably situated very close to the plane of the diverting roller 40. As tangential a feed as possible can be achieved in this way.

FIG. 8 shows a longitudinal section through a roller system 10 once again, without a diverting roller and without a traction cable. As a result of the angular deflection of the guide surface 51, the two sections of the guide surface 51 span, on the side of the diverting roller, a reflex angle β. A guide surface however need not be formed by two surface sections that run at an angle β relative to one another, it rather also being possible for an advantageous diversion of a traction cable within the meaning of the invention to be achieved by means of an altogether curved guide surface. The convex side of a curved guide surface then points in the direction of the diverting roller. Such a curved or domed guide surface is arranged relative to the diverting roller such that it diverts a traction cable, when the latter bears against the guide surface, into a direction tangential with respect to the diverting roller. A funnel or half-funnel formed by multiple guide surfaces would, in the case of such an embodiment, have the form of a chalice.

Such a roller system may be mounted in various orientations on the vehicle body. For example, it can be installed such that the diverting roller runs vertically and its axis of rotation runs horizontally. Installation with a vertical diverting roller and a horizontally running axis of rotation of the diverting roller would also be possible.

What is claimed:

1. A cable guide arrangement, comprising:
a traction cable; and
a roller system to divert said traction cable, said roller system including a holder having a diverting roller and a guide channel through which said traction cable is guided to said diverting roller, said guide channel having at least one guide surface whereby when said traction cable bears against said guide surface, said traction cable is diverted in a direction of a tangential profile in relation to said diverting roller.

2. The cable guide arrangement as claimed in claim 1, wherein the guide channel has at least one angled guide surface, an angular deflection of which on a side of the diverting roller has a reflex angle β.

3. The cable guide arrangement as claimed in claim 2, wherein the angular deflection on the side of the diverting roller is of rounded form.

4. The cable guide arrangement as claimed in claim 1, wherein the guide channel has at least one curved guide surface, a convex side of which points toward the diverting roller.

5. The cable guide arrangement as claimed in claim 4, wherein said at least one guide surface runs, in a region of the diverting roller, substantially parallel to a plane of the diverting roller.

6. The cable guide arrangement as claimed in claim 5, wherein multiple guide surfaces form a funnel, by which a conically tapering guide channel is formed.

7. The cable guide arrangement as claimed in claim 5, wherein multiple guide surfaces form a partial funnel which points with an open longitudinal side toward the diverting roller.

8. The cable guide arrangement as claimed in claim 5, wherein the roller system is mounted at an end of a rail through which the traction cable runs.

9. The cable guide arrangement as claimed in claim 8, wherein the rail has a curved section with an inner flank, the traction cable sliding along said inner flank of the curved section during opening and/or closing of a vehicle sliding door.

10. The cable guide arrangement as claimed in claim 9, wherein in an installed state of the cable guide arrangement, the diverting roller lies vertically, and its axis of rotation runs horizontally.

11. The cable guide arrangement as claimed in claim 3, wherein said at least one guide surface runs, in a region of the diverting roller, substantially parallel to a plane of the diverting roller.

12. The cable guide arrangement as claimed in claim 11, wherein multiple guide surfaces form a funnel, by which a conically tapering guide channel is formed.

13. The cable guide arrangement as claimed in claim 11, wherein multiple guide surfaces form a partial funnel which points with an open longitudinal side toward the diverting roller.

14. The cable guide arrangement as claimed in claim 11, wherein the roller system is mounted at an end of a rail through which the traction cable runs.

15. The cable guide arrangement as claimed in claim 14, wherein the rail has a curved section with an inner flank, the traction cable sliding along said inner flank of the curved section during opening and/or closing of a vehicle sliding door.

16. The cable guide arrangement as claimed in claim 15, wherein in an installed state of the cable guide arrangement, the diverting roller lies vertically, and its axis of rotation runs horizontally.

17. The cable guide arrangement as claimed in claim 1, wherein the roller system is mounted at an end of a rail through which the traction cable runs.

18. The cable guide arrangement as claimed in claim 17, wherein the rail has a curved section with an inner flank, the traction cable sliding along said inner flank of the curved section during opening and/or closing of a vehicle sliding door.

19. The cable guide arrangement as claimed in claim 18, wherein in an installed state of the cable guide arrangement, the diverting roller lies vertically, and its axis of rotation runs horizontally.
